(19) United States
(12) Patent Application Publication
(10) Pub. No.: US 2003/0054135 A1
(43) Pub. Date: Mar. 20, 2003

(54) Composite structural element

(76) Inventor: Paul Roberts, Mt. Grayatt (AU)

Correspondence Address: MASON, MASON & ALBRIGHT, 2306 South Eads Street, P.O. Box 2246, Arlington, VA, 22202, US

(21) Appl. No.: 10/256,068

(22) Filed: Sep. 27, 2002

Related U.S. Application Data
(63) Continuation of application No. PCT/AU01/00344, filed on Mar. 28, 2001.

(30) Foreign Application Priority Data
Mar. 28, 2000 (AU) PQ6517

(51) Int. Cl. B32B 3/00

(52) U.S. Cl. 428/172; 264/229; 264/152; 264/134

(57) ABSTRACT

A composite structural element (10) includes one or more tyre tread portions (16) encapsulated in a casing (14) preferably formed from a settable liquid, and being of a rigidity sufficient for said tread portions (16) to be held substantially straight by the casing and is adhesively engaged with the tread portions. The method of forming the composite structural element (10) includes removing the tread portion from a tyre, cutting the thread portion at least once across its tread, forming or holding the cut tread portion substantially straight, encapsulating the straightened tread portion in a settable liquid, and allowing or causing the settable liquid to set to form the casing with the straightened tread portion encased therein.

### TECHNICAL FIELD

This invention relates to a composite structural element and a method of forming composite structural elements. More particularly, the invention relates, to a composite structural element having as a component the tread portion of a tyre and a method of forming same.

### BACKGROUND ART

Disposal of used tyres is a long recognised and significant environmental problem. Recycling of used tyres has been attempted, often employing a comminution step in order to provide a rubber crumb for re-use. However, the cords and beads in the tread and rims of each tyre cause difficulties in the comminution process. The walls of the tyres are more readily comminuted because they are generally not formed as a composite of rubber encapsulating other materials, but as homogeneous rubber.

It is an object-of the present invention to provide a composite structural element having as a component one or more tread portions of a tyre. It is another object to provide a method of disposal of the tread portion of tyres by including them in composite structural elements. It is another object of the invention to provide a method of forming a composite structural element with one or more tyre tread portions as a component.

### SUMMARY OF THE INVENTION

With the foregoing in view, the present invention in one aspect resides broadly in a composite structural element including one or more tyre tread portions, and a casing substantially encapsulating said tread portions, said casing being sufficiently rigid to hold said tread portions substantially straight.

Preferably, the casing is formed from a settable liquid and is adhesively engaged with the tread portions. The tread portions are preferably held straight whilst the settable liquid is placed around the tread portion and allowed to set whereby the composite structural element thus formed is elongate in form and substantially straight. Where more than one tread portion is encapsulated into a single structural element, it is preferred that they be aligned side by side in edge abutting or spaced apart relationship to form a layer which when encapsulated forms a panel. For thicker panels, it may be desirable to arrange the tread portions in two or more layers, with the tread portions crossing over one another. Alternatively, the tread portions may be aligned in a lamellar fashion. However, in a preferred embodiment, each composite structural element includes only one tread portion, and is of elongate form, such as a beam, joist, paling or the like.

In another aspect, this intention resides broadly in a method of forming a composite structural element, including the steps of:

removing the tread portion from a tyre;

cutting the tread portion at least once across its tread;

forming or holding the cut tread portion substantially straight;

encapsulating the straightened tread portion in a settable liquid; and

allowing or causing the settable liquid to set to form a casing with the straightened tread portion encased therein.

In one form of the method, the tread portion is immersed in the settable liquid in a mould, but preferably the settable liquid is poured or caused to flow into the mould to surround and then cover the tread portion and the liquid is allowed or caused to set. Suitably, cavities or bubbles are minimised in the settable liquid such as by orienting the mould at alternative angles and/or evacuation of the mould prior to introduction of the liquid. If desired, a surface treatment or adhesive may be coated onto the tread portion to enhance bonding between the settable liquid and the tread portion.

Preferably, the settable liquid includes an epoxy or polyurethane type resin which may include additives, such as a fire retardant. Suitably, the settable liquid is selected to set with sufficient strength and to hold the tread portion in its straightened arrangement. It is preferred that the settable liquid also includes a filler material such as rubber crumb obtained from the walls of recycled tyres. Advantageously, in such form the invention allows more of the tyre to be used in the structural element and at the same time provides improved noise insulation properties.

Advantageously, the tread pattern on surface of the tread portion provides a key for the set liquid. Thus it is preferable to use tyres which have a pre-determined amount of tread remaining. If such tyres are unavailable then tyres may be partially regrooved if desired. Similarly, a second tread or keying pattern may be provided on the side opposite the normal tyre tread to provide extra keying, or apertures may be cut through the tread portion.

In one form, the tyre tread is longitudinally pre-tensioned in a mould so that when the composite structural element is released from the mould, the casing is put under an axial compressive load. That is, the tread portion is placed under a tensile force prior to encapsulation so that when the tension on the tread portion is released, the set liquid (forming the casing) is placed under a compressive stress, thus providing a pre-stressed composite structural element. It will be appreciated that in cases where the tread is pre-tensioned, an amount of the tread portion is exposed beyond the casing. These exposed portions may be trimmed off, but for non-prestressed composite structural elements, the ends of the tread portions are typically encapsulated by the casing.

If desired, the opposed longitudinal sides of the structural element may each be shaped to inter-engage with a corresponding longitudinal side of another structural element. For example, each structural element may be configured with a tongue and groove on respective opposed side edges.

Preferably the tread portion is obtained from the entire tread of the tyre. However, for shorter or smaller composite structural elements, the tread portion may be reduced in size, generally in length, but also in width if desired. A reduction in the thickness of the tread portion is not considered to be practical.

In one example of the invention, the side walls were cut from a 185/70×14 tyre to separate them from the tread and casing. A cut was made across the tread and casing so that it could be laid out flat. The tread portion was prepared for adhesion to a settable liquid described below by buffing the surface and applying cold vulcanising solution to the buffed surface of the tread portion. A mould was prepared having dimensions appropriate for the tyre tread when laid out flat. The mould was of box-like construction open at the top and bottom, 200 mm wide and 2.2 metres long (inside dimensions with clamps formed in the ends to hold the tread portion out flat. A mould release agent was applied to the, internal, surfaces of the mould and the tread was laid in the mould and clamped in the end clamps. The tread was stretched slightly and positioned in the mould with the tread side facing upwards approximately centrally about the longitudinal axis of the mould. A removable bottom to the mould was treated with mould release agent inserted into the mould against the underside of the tread casing. Comminuted rubber powder/crumb (from the side walls of the tyre) of approximately 30 mesh was preheated and mixed with additives comprising talc and vibrathane binder. Approximately 10 kg of rubber powder/crumb was used and the vibrathane was prepared according to the manufacturer's instructions. After mixing, a small amount of water was added and mixed into the liquid to accelerate curing. Some of the settable mixture was poured into the mould to a level sufficient to cover the tyre tread and supported on the removable bottom. The lid of the mould was then treated with mould release agent and sealingly secured to the top of the mould. The mould was then inverted and the removable bottom removed. More of the settable mixture was added to the mould to cover the inner side of the tread portion which was then facing upwards due to the inversion of the mould, the amount of mixture being added being sufficient to encapsulate the tread portion. This procedure was adopted to minimise the occurrence of air bubbles in the structural element when formed. After setting of the settable mixture, the ends of the tyre protruding from the partially formed composite element were encapsulated one at a time in an end mould having the same cross-section as the partially formed composite element. For each end, more of the settable mixture was added to encapsulate the protruding ends and then allowed to set. Mould release agent was added to the end mould prior to use. After setting, the finished sample was 195 mm wide and 2.1 metres long, with a substantially constant thickness of 20 to 25 mm. Because the tread and casing were stretched for the moulding process, the finished sample was “pre-stressed”, the vibrathane casing (except that part encapsulating the formerly protruding end portions of the tread portion) being placed under compressive load along the longitudinal axis of the structural element.

### BRIEF DESCRIPTION OF THE DRAWINGS

In order that the invention may be snore readily understood and put into practical effect, reference will now be made to the following drawings which illustrate a preferred embodiment of the invention and wherein:

FIG. 1 is diagrammatic pictorial view of a composite structural element according to the invention;

FIG. 2 is a diagrammatic end view of the composite structural element of FIG. 1;

FIG. 3 is a more detailed diagrammatic end view of the composite element of FIGS. 1 and 2; and

FIGS. 4 to 8 show schematically in diagrammatic sectional view the method of encapsulating a tread portion in accordance with the invention.

### DETAILED DESCRIPTION OF THE DRAWINGS

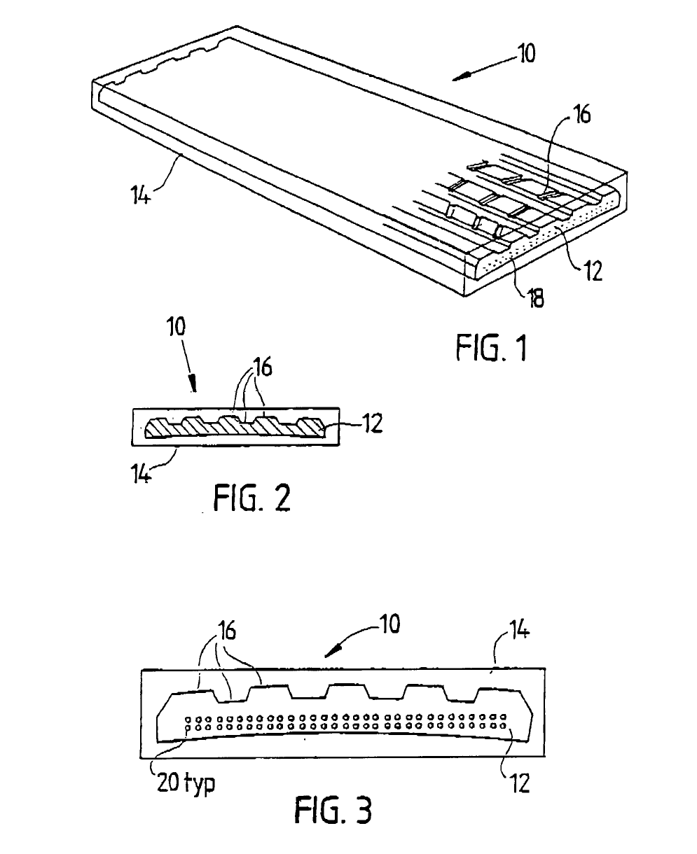

The composite structural element 10 shown in FIGS. 1 and 2 includes a tread portion 12 from a tyre encapsulated or embedded in a casing 14 in the form of an elongate rectangular prism, with the casing keyed into the tread 16 (shown in diagrammatically FIG. 1). The tread portion 12 is substantially central within the casing about the longitudinal axis and the end of the tread portion is exposed at 18, but trimmed to the same length as the casing 14 after the casing has set.

Referring to FIG. 3, the cords of the tread portion 12 are shown typically at 20 and apply a longitudinal compressive force on the casing in the finished product due to the tread portion 12 having been pre-stressed with a tensile force prior to the setting of the casing.

The composite structural element of the present invention is believed to be suitable for non-load bearing structural applications, particularly, for example, as a paling for fences. However, it will be readily seen that the structural element may be used in other applications. The pre-stressed composite structural element of the present invention may be used, for example, as a flooring panel.

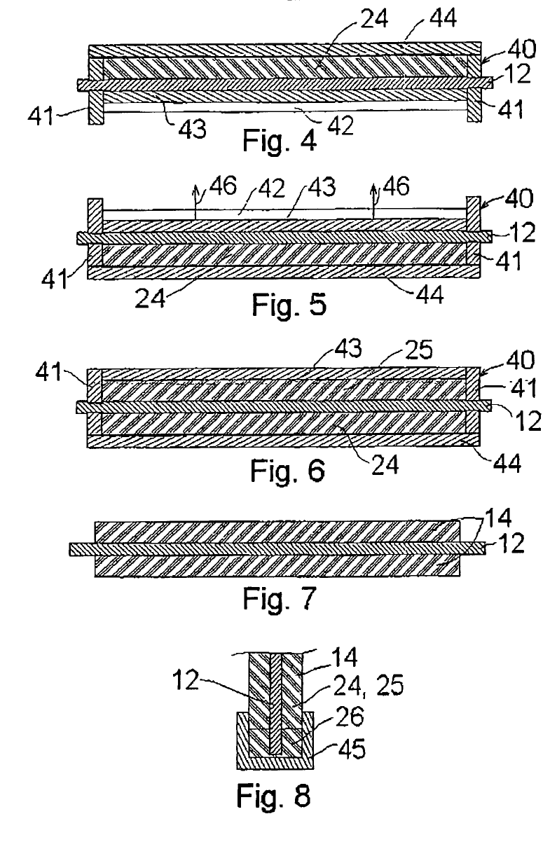

An example method of the invention is shown schematically in FIGS. 4 to 8. The tread portion 12 is clamped between the end walls 41 of a mould 40 as shown in FIG. 4. A removable bottom. 43 is inserted between the end walls and the side walls 42 until it abuts the underside of the tread portion. Settable liquid 24 is poured into the mould and a lid 44 secured to the top of the mould.

As shown in FIG. 5, the assembly is inverted so that the lid is at the bottom, and the removable bottom raised in the direction of arrows 46 until it is at the position shown in FIG. 6. More settable liquid 25 is also added and allowed to set, whereupon the mould 40 is removed to expose the partially formed structural element which has the ends of the tread portion protruding a short distance as shown in FIG. 7. The partially formed structural element is stood on its end in an end mould 45 having more settable liquid 26 therein as shown in FIG. 8. Each end of the structural element is formed by this technique.

While the invention has been described with reference to one or more specific examples, it will be appreciated by persons skilled in the art that the invention may be embodied in other forms within the broad scope and ambit of this invention as claimed in the following claims.

1. A composite structural element including one or more tyre tread portions, and a casing substantially encapsulating said tread portions, said casing being sufficiently rigid to hold said tread portions substantially straight.

2. A composite structural element according to claim 1, wherein the casing is formed from a settable liquid and is adhesively engaged with the tread portions.

3. A composite structural element according to claim 1 or claim 2, having one tread portion, wherein the tread portion is held under tension by the casing and the casing is under corresponding compression.

4. A method of forming a composite structural element, including the steps of:
removing the tread portion from a tyre;
cutting the tread portion at least once across its tread;
forming or holding the cut tread portion substantially straight;
encapsulating the straightened tread portion in a settable liquid; and
allowing or causing the settable liquid to set to form a casing with the straightened tread portion encased therein.

5. A method according to claim 4, wherein the settable liquid is poured or caused to flow into a mould to surround and then cover the tread portion and the liquid is allowed or caused to set.

6. A method according to claim 4 or claim 5, wherein the settable liquid includes a filler material.

7. A method according to claim 6, wherein the filler material includes a rubber crumb obtained from the walls of recycled tyres.

8. A method according to any one of claim 4 to 7, wherein a surface treatment or adhesive is coated onto the tread portion to enhance bonding between the settable liquid and the tread portion.

9. A method according to any one of claims 4 to 8, wherein the settable liquid includes an epoxy or polyurethane type resin having incorporated therein a filler material.

10. A method according to any one of claims 4 to 9, and including forming a second tread or keying pattern on the side opposite the normal tyre tread.

11. A method according to claim 10, wherein said keying pattern includes a plurality of apertures cut through the tread portion.

12. A method according to any one of claims 5 to 11, including pre-tensioning the tyre tread longitudinally with a force sufficient that when the composite structural element is released from the mould, the casing is put under an axial compressive load.

13. A composite structural element substantially as hereinbefore described with reference to the accompanying drawings.
